(19) United States
(12) Patent Application Publication
(10) Pub. No.: US 2026/0056723 A1
(43) Pub. Date: Feb. 26, 2026

(54) TRANSLATING COMPUTER CODE USING AUGMENTED PROGRAM ANALYSIS

(71) Applicant: INTERNATIONAL BUSINESS MACHINES CORPORATION, Armonk, NY (US)

(72) Inventors: Venkatesan Thirumalai Chakaravarthy, Karnataka (IN); Anamitra Roy Choudhury, Vasant Kunj (IN); Dinesh Garg, Beawar (IN); Yogish Sabharwal, Gurgaon (IN); Amith Singhee, Bangalore (IN)

(21) Appl. No.: 18/815,022

(22) Filed: Aug. 26, 2024

(51) Int. Cl. G06F 8/41

(52) U.S. Cl. CPC G06F 8/4435

(57) ABSTRACT

Systems and method for translating computer code using augmented program analysis. Augmented program metadata for a target computer code from an original code can be constructed by generating target class structure and target method prototype. Extraneous code can be filtered from the original code based on determined code compatibility to obtain filtered source code. A prompt can be generated using pairs of the augmented program metadata and the filtered source code that are fed to a trained large language model to obtain generated translated code. The generated translated code can be optimized to ensure code compilability, avoid redundancies, and enhance memory handling. A computer software application can be translated by compiling generated translated code.

### BACKGROUND

The present invention generally relates to autonomous computer code generation, and more particularly to translating computer code using augmented program analysis.

Currently, there are some technical fields where the majority of entities still use archaic software systems that are in dire need of modernization. These archaic software systems can be programmed using legacy programming languages such as COBOL, PL/I, ASSEMBLER, etc., which are rarely used in modern computer programming. Due to the obsolescence of legacy programming languages, maintaining such archaic software systems can become problematic due to integration challenges caused by incompatibility to other modern systems, scarcity of skilled programmers, slow software development speed, and limited technical support.

### SUMMARY

In accordance with an embodiment of the present invention, a computer-implemented method for translating computer code using augmented program analysis is provided, including, constructing augmented program metadata from an original code by generating target class structure and target method prototype, filtering extraneous code from the original code based on determined code compatibility to obtain filtered source code, generating a prompt using pairs of the augmented program metadata and the filtered source code that are fed to a trained large language model to obtain generated translated code, optimizing the generated translated code to ensure code compilability, avoid redundancies, and enhance memory handling, and compiling the generated translated code into a translated software application.

In accordance with another embodiment of the present invention, a system is provided, including, a memory device, and one or more processor devices operatively coupled with the memory device to construct augmented program metadata from an original code by generating target class structure and target method prototype, filter extraneous code from the original code based on determined code compatibility to obtain filtered source code, generate a prompt using pairs of the augmented program metadata and the filtered source code that are fed to a trained large language model to obtain generated translated code, optimize the generated translated code to ensure code compilability, avoid redundancies, and enhance memory handling; and compile the generated translated code into a translated software application.

In accordance with yet another embodiment of the present invention, a computer program product for translating computer code using augmented program analysis is provided, the computer program product including a computer readable storage medium having program instructions embodied therewith, the program instructions executable by a processor device to cause the processor device to construct augmented program metadata from an original code by generating target class structure and target method prototype, filter extraneous code from the original code based on determined code compatibility to obtain filtered source code, generate a prompt using pairs of the augmented program metadata and the filtered source code that are fed to a trained large language model to obtain generated translated code, optimize the generated translated code to ensure code compilability, avoid redundancies, and enhance memory handling, and compile the generated translated code into a translated software application.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a flow diagram illustrating the computer-implemented method for translating computer code using augmented program analysis, in accordance with an embodiment of the present invention;

FIG. 2 is a block diagram showing a computing system for translating computer code using augmented program analysis, in accordance with an embodiment of the present invention;

FIG. 3 is a block diagram illustrating a control flow graph generated from a source code, in accordance with an embodiment of the present invention;

FIG. 4 is a block diagram illustrating an abstract structure tree generated from a source code, in accordance with an embodiment of the present invention;

FIG. 5 a block diagram illustrating the mapping relationship between an original code and a target computer code, in accordance with an embodiment of the present invention;

FIG. 6 is a block diagram illustrating a software implementation of translating computer code using augmented program analysis, in accordance with an embodiment of the present invention; and

FIG. 7 is a block diagram illustrating deep learning neural networks for translating computer code using augmented program analysis, in accordance with an embodiment of the present invention.

### DETAILED DESCRIPTION

In accordance with embodiments of the present invention, systems and methods are provided for translating computer code using augmented program analysis. The present embodiments can solve the issues associated with archaic software systems programmed with obsolete programming languages by translating computer code using artificial intelligence (AI) with augmented program analysis metadata.

With the present embodiments, an entire software application can be translated from its source programming language to a target programming language using AI with augmented program analysis metadata. To enable an AI model to process the entire software application, target computer code can be constructed with autonomous program analysis that autonomously designs code hierarchy, code flow, and data implantation from a source code. Target computer code can be constructed by generating target class structure and target method prototype. Target class structure can include member variables and class hierarchy specification based on class data structure code mapped with class data handling code. Target method prototype can include mapped code segments converted from original code procedures into the target class structure. Extraneous code from the original code can be removed based on determined code compatibility between the target computer code and the original code. The target computer code and the original code can be paired to generate a prompt that can be fed to a trained large language model (LLM) to obtain generated translated code. The generated translated code can be optimized to ensure code compilability, avoid redundancies, and enhance memory handling. Code compilability is the ability of computer code to be compiled without errors. The generated translated code can be compiled into a translated software application for deployment.

Existing program analysis software and trained LLMs can be used to translate computer code from one programming language to another. However, these current methodologies are deficient in terms of scale and maintainability.

Program analysis software such as Mastery™ or RecordGen™ can be used to translate computer code from one programming language to another. However, the resulting translated code can be different from computer software natively programmed with the target programming language. For example, computer code written in COBOL would be translated into Java, but the original memory layout in COBOL is maintained in the translated code, which is unnatural. Additionally, maintaining the translated code from such program analysis software would necessitate expertise of both target programming language and source programming language which can be costly.

Trained LLMs such as ChatGPT™, LLaMa™, and CodeBERT™ can be used to translate computer code from one programming language to another. However, these LLMs can only handle small-scale programs and cannot understand complex large-scale software applications. Additionally, these LLMs cannot produce consistent object-oriented design for an entire software application.

The present embodiments solve the issues associated with archaic software systems programmed with obsolete programming languages by translating such computer code using augmented program analysis metadata. The present embodiments improve autonomous code generation of translated computer code by making the generated translated code easier to maintain by filtering extraneous code that are determined to be incompatible with a target programming language. By filtering extraneous code from the original code, compile time of the generated translated code can be faster and more efficient memory handling as the generated translated computer code no longer has to compile the incompatible data structures which results in faster compile times and more efficient memory handling.

Additionally, the present embodiments improve computer software maintenance by modernizing the computer software itself making it more adaptable to new technologies and methodologies that would be otherwise incompatible with archaic programming languages. Furthermore, the present embodiments improve the generated translated code by making it more streamlined to look as if the generated translated code was natively programmed with the target programming language. It is noted that some embodiments may not have these potential advantages and these potential advantages are not necessarily required for all embodiments.

Exemplary applications/uses to which the present invention can be applied include, but are not limited to: modernizing government computer software systems such as welfare programs, converting insurance claims systems, updating legacy computer software components, integrating software application deployed in a distributed computing environment into a more complex computer software developed in a different programming language or programming framework, and autonomous comment and documentation generation in a computer code based on the translations made from the source programming language to another.

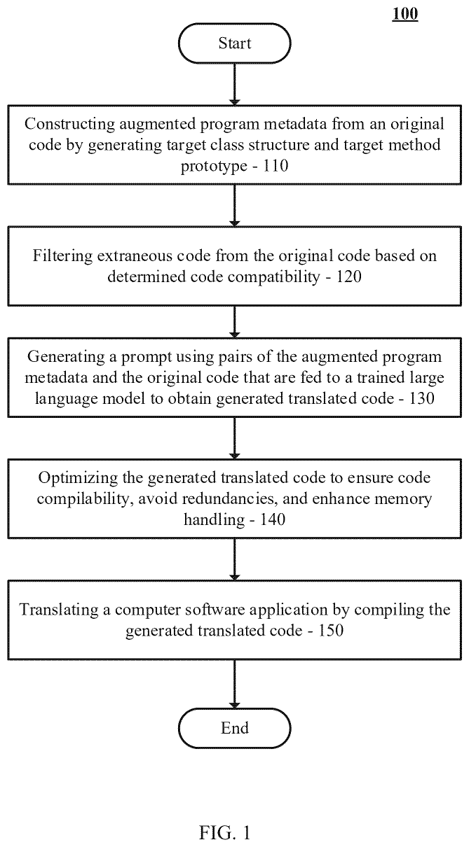

Referring now to the drawings in which like numerals represent the same or similar elements and initially to FIG. 1, a flow diagram illustrating the computer-implemented method for translating computer code using augmented program analysis, in accordance with an embodiment of the present invention.

In an embodiment, an entire computer software application can be converted from its legacy source programming language to a target programming language by utilizing augmented program analysis metadata and artificial intelligence. Augmented program analysis metadata can include code hierarchy, code flow, and data implementation analyzed from an original code. The augmented program analysis metadata of a target computer code can be constructed with autonomous program analysis to generate target class structure and target method prototype. Target class structure can include member variables and class hierarchy specification based on class data structure code mapped with class data handling code. Target method prototype can include parameters, return type, and local variables converted from the original code. Additionally, target method prototype can include code segments that were converted from code procedures from the original code which can be mapped to target class structure.

Extraneous code can be filtered from the original code based on determined code compatibility to enhance code compilability, speed up compile time, and enhance memory handling efficiency. A prompt using pairs of the augment program metadata and the original code can be generated to be fed to a trained LLM to obtain generated translated code. The generated target code can be optimized further to ensure code compilability and avoid redundancies further improving compile time and memory handling efficiency. The generated target code can be compiled into a target software application.

In block 110, augmented program metadata for a target computer code can be constructed by a processor device with autonomous program analysis from an original code.

In an embodiment, augmented program metadata can be a series of snippets of computer code that can include code hierarchy, code flow, data implementation, and their respective relationships, from the original code.

Code hierarchy can refer to how different code procedures stack up with one another which can include code inheritance. Code procedures can be lines of code that are programmed to do something, such as, showing “Hello World” to the screen. Code inheritance can refer to how similar code procedures can obtain code snippets from another code procedure. For example, code procedure A can be inside code procedure B. Code procedure B can inherit code snippet D from code procedure C. Thus, calling code procedure B allows the programmer to also perform code snippet D.

Code flow can refer to how the processing of the code procedure is performed in relation to processing time. Examples of code flow mechanisms can include loops (e.g., while, for, do-while), breaks, jumps (e.g., goto), conditional statements (e.g., if/then/else, switches), etc.

Data implementation can refer to how data is utilized within a code procedure. Examples of data implementation mechanisms can include variables, literals (e.g., literal numbers in an equation), data structures (e.g., class, arrays, etc.).

In an embodiment, there can be several types of augmented program metadata, e.g., target class structure, target method prototype, and target procedure code.

Target class structure can refer to code that defines the structure and relationships of a class (e.g., class in object oriented programming) that is written in the target programming language. The target class structure can include class hierarchy specification (e.g., code hierarchy for classes), class data structure code, and class data handling code. The target class structure can also include the name of the class, and type of the class (e.g., accessibility of the class in relation to other code such private, public, protected, etc.). The target class structure can be generated by a class designer module.

Class data structure code can include code that handles data internally within a class such as member variables. Member variables are variables that are handled by a class. For example, in the code snippet: class A {int x;} class B {int y;}, x is a member variable of class A, while y is not a member variable of class A.

Class data handling code can include code that handles data externally from the source code itself, such as database connections. Class data handling code can also include file handling code.

Target method prototype can refer to code that defines the structure and relationships of a method that is written in the target programming language. The structure of the target method prototype can include method parameters, method return type, method name, and local variables. The method parameters can be code mechanisms that enable data to be passed into a method. The method return type can be code specification on what data type the particular method would process its output. Local variables can be variables that are initialized within the method. For example, in the code snippet: int methodX (int a) {int b; return b+a;}, the “int” adjacent to the class name “methodX” is the return type, “a” inside the parenthesis is the method parameter, and “b” is a local variable.

The relationships of methods (e.g., reaching definitions) can refer to how method calls within other methods can occur. For example, method A can call on method B, and method B can call on method C, thus, calling method A would ultimately call on method C. The following relationship can be graphed as a control flow graph as: A→B→C.

The target method prototype can be generated by a method designer module.

Target procedure code can refer to code that defines the code that performs the logic of the program that is written in the target programming language. For example, in the code snippet: int addXY(int x, int y){return x+y;)}, “return x+y;” is the target procedure code.

Referring now to how target class structure can be generated based on class data structure code mapped with class data handling code through autonomous program analysis.

In an embodiment, target class structure, that includes member variables and class hierarchy specification, can be generated based on class data structure code and class data handling code.

To generate class data structure code, the code syntax of the source code can be analyzed and learned to determine the placement of a variable declaration, such as indentation. For example, a variable declaration that is indented after a class declaration can be determined to be a member variable. Additionally, to generate member variables, variable declarations from the original code can be mapped to corresponding target programming language counter parts based on predefined data type mappings. For example, a predefined data type mapping for converting COBOL variable definitions to Java variable definitions can include “PIC 9(10)=int” which defines the COBOL variable definition having “PIC 9(10)” corresponds to a Java variable initialization with an int data type.

To generate class hierarchy specification, code declarations and code syntax used in the original code can be analyzed and compared to a predetermined hierarchical mapping which are based in ground truth hierarchical mappings. The predetermined hierarchical mapping can be how classes, methods, and procedures are programmed which can include their order of processing upon run time. The predetermined hierarchical mappings can be further analyzed by the class designer module to generate the class hierarchy specification.

To generate class data handling code, the syntax of original code can be parsed and compared to a predetermined external data handling mapping can be utilized. For example, an external data handling mapping can include “SQL=SQL Connection” which can flag parsed code with “SQL” triggers an SQL Connection and corresponding SQL handling with the target programming language.

The generated class data handling code and class data structure code can be mapped according to a class hierarchy specification that indicates a relationship between external and internal data handling. For example, a member variable can be identified that can handle an external database output.

The predetermined data type mappings, hierarchical mapping, and external data handling mapping can be learned by a context learning model that can capture relationships between related words of two distinct texts (e.g., data type mappings, hierarchical mapping, external data handling mapping, class hierarchy) such as graph neural networks, large language models. The context learning model can use corresponding ground truth data to learn the predetermined data type mappings, hierarchical mappings, and external data handling mappings.

In an embodiment, unused classes and variables in the original code can be filtered out from the target class structure. To determine unused classes and variables, the initialization section of the original code can be parsed and the procedure section of the original code can be checked whether the classes and variables are actually utilized through their occurrence within the procedure section. In an embodiment, classes and variables can be reused based on their occurrence with the procedure section.

Referring now to how target method prototype can be generated from code segments converted from original code procedures through autonomous program analysis.

In an embodiment, target method prototype can be generated from code segments converted from original code procedures. Original code procedures can be code snippets that are included in a procedure section of a source computed code. The procedure section of the original code can contain the logic of the original code.

To generate target method prototype, the original code procedures can be analyzed and compared to a predetermined method differentiator. The predetermined method differentiator differentiates a method call to other program construct calls based on the context of original code. For example, an original code stating to “Accept X” with a procedure definition of “X” would flag that “X” was a method, and “Accept X” as the method call. The predetermined method differentiator can be included in the context mapping model.

Classes can have class methods, which are methods defined within a class. To obtain class methods, the original code can be mapped to target class structure based on the determined reaching definitions of the original code. The reaching definitions of a code is based on a control flow graph which maps how a code segment can be reached. For example, if a reaching definitions of a code segment identifies that the code segment is defined within a class, then the code segment is a class method. In other instances, the code segments can be standalone which can be associated to a default class.

To determine the reaching definitions of an original code segment, a control flow graph can be generated for each code segment identified as a method by performing data analysis which can also define the local variables or parameters of the method. Additionally, affinity heuristics can be employed to associate parameters and local variables to a target method prototype. An affinity heuristic can determine the occurrence of a variable defines in relation to an identified method and compare it to a predetermined threshold that is mapped for local variables or parameters. For example, the number of occurrences exclusively identified within a method definition can be a local variable, otherwise, it is a parameter.

The control flow graph can also include control flow statements that are defined in the original code. In an embodiment, refactored code from the original code to handle control flow statements can be generated based on a determined control flow graph and a determined compatibility. For example, method A defined a jump into method B, the corresponding graph can be A→B, and if the target programming language supports this (e.g., goto, class method call) then, a refactored method prototype can be generated to enable such determined control flow statement.

In block 120, extraneous code from the original code can be filtered based on determined code compatibility to obtain filtered source code.

In an embodiment, extraneous code from the original code can be filtered out based on determined code compatibility. Extraneous code can refer to code snippets from the original code that are incompatible with the target programming language based on a determined code compatibility which has no central logic in the original code or is simply redundant code. For example, data structures that are used in COBOL such as PCB, PSB but are eliminated in Java, code snippets containing such incompatible data structures can be filtered out. To filter the extraneous code, the identified extraneous code can be removed entirely from the source code, obtaining a filtered source code.

To determine whether to filter out code, a relationship between the original code and a determined code compatibility of the target programming language can be identified. The determined code compatibility can refer to the code syntax and capabilities of a programming language. For example, COBOL has PCB and PSB data structure, while Java does not. The relationship of code with an identified incompatible code can be determined based on the context of the code. For example, a source code can initialize the PCB data structure, add data to the initialized PCB data structure, and print the PCB data structure. The code procedures for the initialization, manipulation and printing of the PCB data structure can be identified as related to the incompatible PCB structure through the keyword “PCB,” procedure encapsulation, or code context (e.g., ending a procedure, or control flow). The determined code compatibility can be learned by the context mapping model by using ground truth data relevant to code compatibility between different programming languages. The present embodiments can detect functional logic (e.g., part of functional logic of the original software application) based on the context and the number of occurrences of the functional code being processed and retain the functional logic intact, while removing the extraneous code.

By filtering out extraneous code from the original code, the resulting translated code is optimized as memory that can be generated and manipulated by the extraneous code can be filtered out, making compiling the resulting translated code faster and its memory management more efficient.

In block 130, a prompt can be generated using pairs of the augmented program metadata and the filtered source code. The prompt can be fed to a trained large language model to obtain generated translated code.

In an embodiment, a prompt can be generated using pairs of the augmented program metadata and the filtered source code. The prompt can be fed to a trained large language model to obtain generated translated code. The prompt can be a series of text that can include a pair of augmented program metadata and an original code.

There can be at least two ways to generate the prompt: static pairing and dynamic pairing. In static pairing, a fixed in-context template can be used to generate the prompts. In dynamic pairing, a prompt pair database can be used. The prompt pair database can be a premade database that contains a template containing pairs of augmented program metadata and corresponding filtered source code. The prompt pair database can be manually populated beforehand. A template can be chosen based on the contents of the input code. In an embodiment, keywords found in the input code can be used to select the template. In another embodiment, the template can be created by generating embeddings for the templates and searching the generated embeddings using an encoder model to find the relationships between the generated embeddings and the input code.

The trained LLM can be OpenAI™ Codex®, DeepMind™ AlphaCode™, IBM® WatsonX® or other LLMs that can be trained to generate code. The generated code by the trained LLM can then be the target procedure code that can be associated with a target method prototype. In another embodiment, the target procedure code can be standalone and can be associated with a default method.

Blocks 110, 120 and 130 can be repeated until every filtered source code has been translated to the target programming language to obtain the generated translated code.

In addition to ensuring that the generated translated code can perform its original purpose, the generated translated code can be optimized to improve the performance of the source software application.

In block 140, the generated translated code can be optimized to ensure code compilability, avoid redundancies, and enhance memory handling.

In an embodiment, the generated translated code can be optimized to ensure code compilability, avoid redundancies, and enhance memory handling. To ensure code compilability, a pre-compiler module can be employed to check for syntax errors and a syntax error fix can be autonomously generated. For example, duplicate declarations or missing end of statement tokens can be autonomously generated to fix potential syntax errors. To enhance memory handling and performance, in-lining of declarations and methods can be used with abstract syntax trees and control flow graphs. The pre-compiler module can generate and process abstract syntax trees and control flow graphs. Abstract syntax trees can represent the structure of a computer code where the node can represent the syntactical entities such as variables, statements, and edges can represent the relationships between the syntactical entities.

In block 150, a computer software application can be translated by compiling the generated translated code.

In an embodiment, the generated translated code can be compiled into a translated computer software application. A compiler can be used to compile the generated translated code into a translated software application. A software packager can be used to package the compiled software into a deployable software application. In another embodiment, the packager can employ the context and syntax learned by the context mapping model, LLM-Code Generator, and a pre-compiler module to generated documentation for the deployable software application.

The present embodiments solve the issues associated with archaic software systems programmed with obsolete programming languages by translating such computer code using augmented program analysis metadata. The present embodiments improve autonomous code generation of translated computer code by making the generated translated code easier to maintain by filtering extraneous code that are determined to be incompatible with a target programming language. By filtering extraneous code from the original code, compile time of the generated translated code can be faster and more efficient memory handling.

Additionally, the present embodiments improve computer software maintenance by modernizing the computer software itself making it more adaptable to new technologies and methodologies that would be otherwise incompatible with archaic programming languages. Furthermore, the present embodiments improve the generated translated code by making it more streamlined to look as if the generated translated code was natively programmed with the target programming language.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

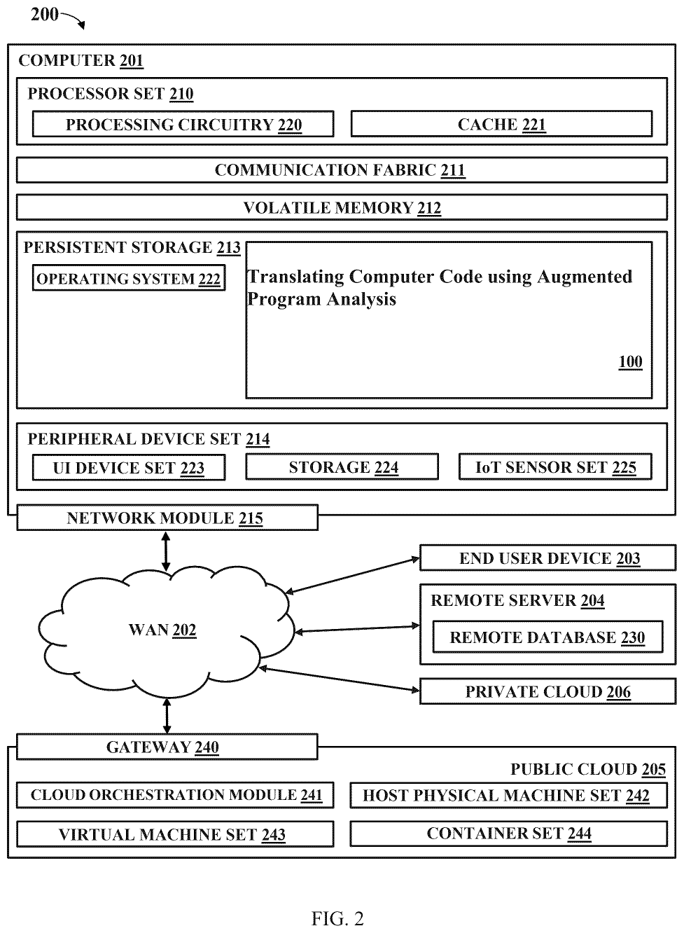

Referring now to FIG. 2, a block diagram showing a computing system for translating computer code using augmented program analysis, in accordance with an embodiment of the present invention.

Computing environment 200 contains an example of an environment for the execution of at least some of the computer code involved in performing the inventive methods, such as translating computer code using augmented program analysis 100. In addition to block 100, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and block 200, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

COMPUTER 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 201, to keep the presentation as simple as possible. Computer 201 may be located in a cloud, even though it is not shown in a cloud in FIG. 1. On the other hand, computer 201 is not required to be in a cloud except to any extent as may be affirmatively indicated.

PROCESSOR SET 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 100, at least some of the instructions for performing the inventive methods may be stored in block 200 in persistent storage 213.

COMMUNICATION FABRIC 211 is the signal conduction path that allows the various components of computer 201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

PERSISTENT STORAGE 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

NETWORK MODULE 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215. WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

REMOTE SERVER 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

PUBLIC CLOUD 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

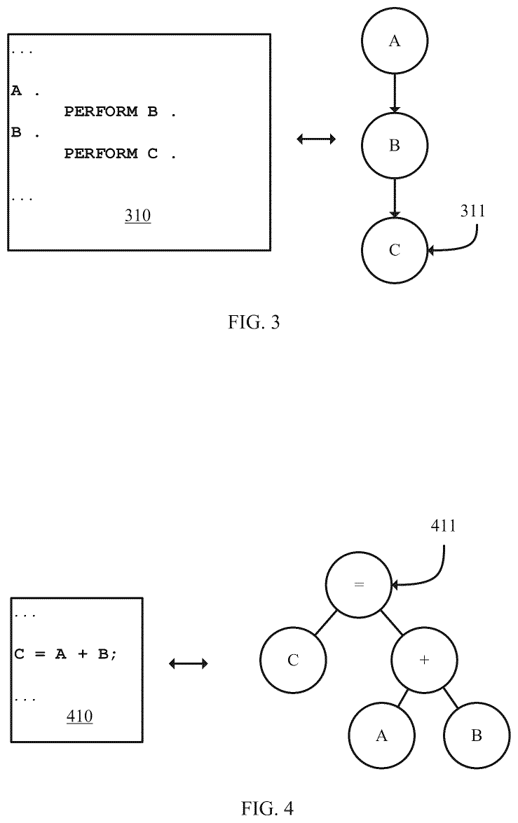

Referring now to FIG. 3, a block diagram illustrating a control flow graph generated from a source code, in accordance with an embodiment of the present invention.

In an embodiment, a control flow graph 311 can be generated from a source code 310. A pre-compiler module can be used to parse the syntax of the source code and generate the control flow graph 311. The nodes of the control flow graph 311 can be the control flow structures such as a method call, control flow statement, etc. The directed edges of the control flow graph 311 can show the process flow from one node to another. The control flow graph 311 can be used by the method design module to construct method signatures, and the class design module to construct class signatures. The control flow graph 311 can also be used to generate the reaching definitions.

Referring now to FIG. 4, a block diagram illustrating an abstract structure tree generated from a source code, in accordance with an embodiment of the present invention.

In an embodiment, abstract structure tree 411, as described herein, can be generated from a source code 410. The pre-compiler module can also be used to parse the syntax of the source code and generate the abstract structure tree 411. The abstract structure tree 411 can be used by the post-processing optimization module and pre-compiler module 616 to ensure code compilability of the target computer code.

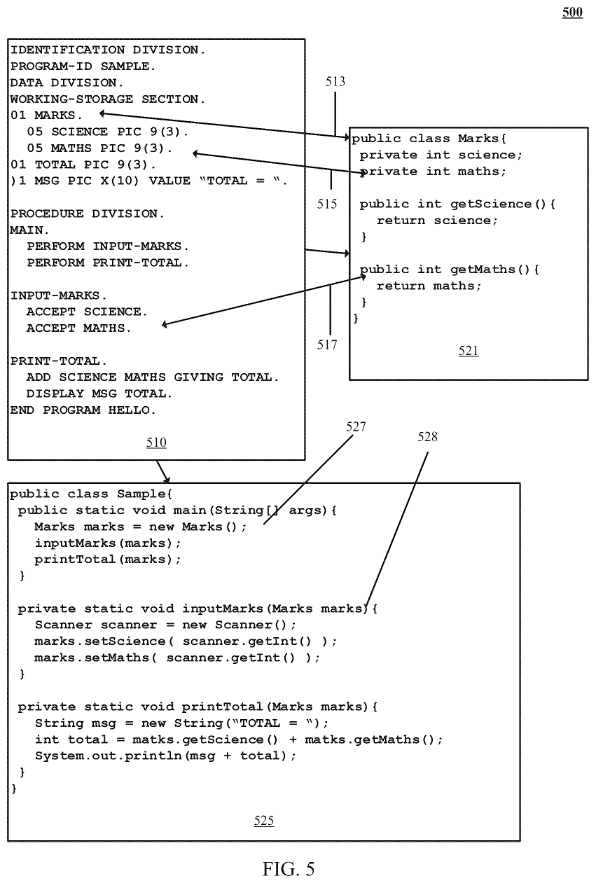

Referring now to FIG. 5, a block diagram illustrating the mapping relationship between an original code and a target computer code, in accordance with an embodiment of the present invention.

In an embodiment, mapping relationship 500 can be learned and employed by context mapping model. The original code 510 can be translated into generated translated code 521 and 525. The code declarations from original code 510 can be mapped to a translated computer snippet for a target computer code 521. For example, code declarations defining a data structure for an object in an original code 510 can be mapped to a translated class signature in target computer code 521, where the mapping 513 can be learned by a context mapping model based on a predefined data type mapping, predetermined hierarchical mapping, and predetermined external data handling mapping. The predefined data type mapping, predetermined hierarchical mapping, and predetermined external data handling mapping can be generated prior to the translation by the context mapping model based on ground truth data type mappings, ground truth hierarchical mappings, ground truth external data handling mappings, respectively. Additionally, code declarations for variables in an original code 510 can be mapped to a translated class variable in the target computer code 521, where the mapping 515 can be learned by the context mapping model. Code declarations defining code flow from one procedure to another in an original code 510 can be mapped to a method signature in target computer code 521 where the mapping 517 can be learned by the context mapping model. The context mapping model can also learn the difference between method parameters 528 and local variables 527 for the target computer code 525 based on a difference metric such as a number of occurrences for a data definition used in the original code 510.

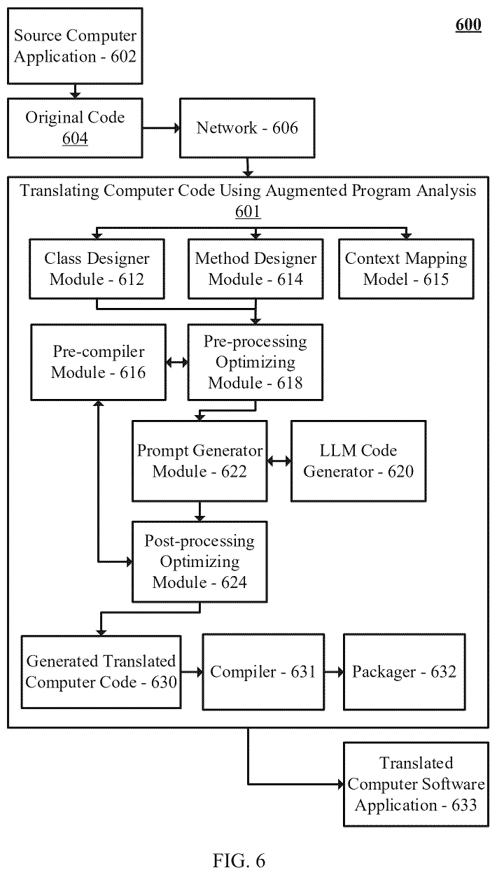

Referring now to FIG. 6, a block diagram illustrating a software implementation of translating computer code using augmented program analysis, in accordance with an embodiment of the present invention.

In an embodiment, a software implementation 600 of translating computer code using augmented program analysis can be employed. A source computer application 602 can be translated into a translated computer software application 633 having a generated translated computer code 630 which is a written in a different programming language than the source computer application 602. An original code 604 of the source computer application 602 can be sent to a network 606 to a computing device that implements translating computer code using augmented program analysis 601. During processing, a class designer module 612 can be used to identify classes from an original code 604 and translate them to the target programming language. A method designer module 614 can also be used to identify methods from an original code 604 and translate them to the target programming language. The class designer module 612 and the method designer module 614 can use a context mapping model 615 which is an AI model that identifies context from the original code to map the original code to a corresponding target programming language counterpart.

After the class designer module 612 and method designer module 614 constructs classes and methods as the augmented program metadata, a pre-processing optimizing module 618 can be used to remove redundancies and extraneous code from the original code 604 using a pre-compiler module 616 to obtain a filtered source code. The present embodiments can detect critical logic based on the context and the number of occurrences of the functional code being processed by using the context mapping model 615 and the pre-compiler module 616.

The filtered source code and the augmented program metadata can be used to generate prompts. The generated prompts can be fed into a LLM code generator 620 to generate translated code based on the generated prompt. The generated translated code can then be processed through a post-processing optimizing module 624, with a pre-compiler module 616, to further optimize the generated translated code to ensure compilability, remove redundancies and enhance memory management and obtain generated translated computer code 630. The generated translated computer code 630 can then be compiled by a compiler 631 and further packaged by packager 632 to obtain the translated computer software application 633.

In another embodiment, the mappings, syntax, and context learned by the context mapping model 615, the pre-compiler module 616 can be used to generate comments regarding the learned mappings and syntax by using the LLM code generator 620 that shows the mapping from the original code to the target programming language. In another embodiment, a documentation manual of the translated software application 633 can be autonomously generated from the mappings, syntax, and context learned by the context mapping model 615, the pre-compiler module 616 can be used to generate comments regarding the learned mappings and syntax by using the LLM code generator 620.

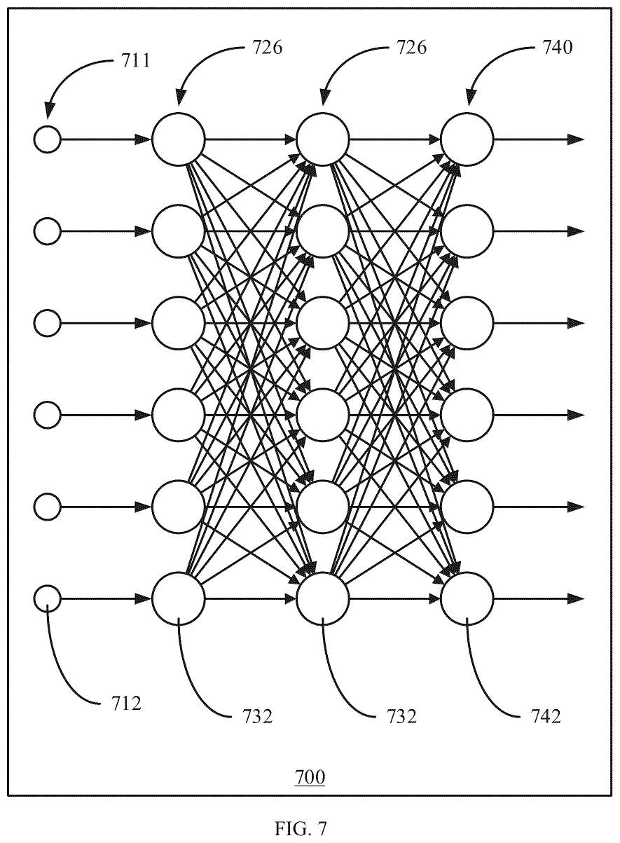

Referring now to FIG. 7, a block diagram illustrating deep learning neural networks for translating computer code using augmented program analysis, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 600, such as a multilayer perceptron, can have an input layer 711 of source neurons 712, one or more computation layer(s) 726 having one or more computation neurons 732, and an output layer 740, where there is a single output neuron 742 for each possible category into which the input example could be classified. An input layer 711 can have a number of source neurons 712 equal to the number of data values 712 in the input data 711. The computation neurons 732 in the computation layer(s) 726 can also be referred to as hidden layers, because they are between the source neurons 712 and output neuron(s) 742 and are not directly observed. Each neuron 732, 742 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 726 of the context mapping model 615 can learn the context and relationships between text to identify code mappings that can include syntax and semantics between different programming languages. The output layer 740 of the context mapping model 615 can then provide the overall response of the network as a likelihood score of an identified context as a potential translation mapping from one programming language to another. In another embodiment, the LLM-Code Generator 620 can generate computer code from the generated prompts. In another embodiment, the LLM-Code Generator 620 can generate comments for the generated computer code based on the context and relationships between the input text (e.g., generated prompts). In another embodiment, the LLM-Code Generator 620 can generate documentation text for the translated software application based on the context and relationships between the input text (e.g., generated prompts).

Training a deep neural network can involve two phases, a forward phase where the weights of each neuron are fixed and the input propagates through the network, and a backwards phase where an error value is propagated backwards through the network and weight values are updated.

The computation neurons 732 in the one or more computation (hidden) layer(s) 726 perform a nonlinear transformation on the input data 712 that generates a feature space. The classes or categories may be more easily separated in the feature space than in the original data space.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for translating computer code using augmented program analysis, comprising:
constructing augmented program metadata from an original code by generating target class structure and target method prototype;
filtering extraneous code from the original code based on determined code compatibility to obtain filtered source code;
generating a prompt using pairs of the augmented program metadata and the filtered source code that are fed to a trained large language model to obtain generated translated code;
optimizing the generated translated code to ensure code compilability, avoid redundancies, and enhance memory handling; and
translating a computer software application by compiling the generated translated code.

2. The computer-implemented method of claim 1, wherein constructing augmented program metadata further comprises generating refactored code from the original code to handle control flow statements that are compatible with the target computer code.

3. The computer-implemented method of claim 1, wherein constructing augmented program metadata further comprises determining parameters, return type and local variables from the original code for the target method prototype.

4. The computer-implemented method of claim 1, wherein constructing augmented program metadata further comprises analyzing a determined control flow graph of the original code to define relationships between code segments and accessed variables.

5. The computer-implemented method of claim 1, wherein constructing augmented program metadata further comprises analyzing reaching definitions using an affinity heuristic to associate target method prototype to target class structure.

6. The computer-implemented method of claim 1, wherein generating a prompt further comprises employing a fixed set of pairs of the target computer code and the original code obtained from a code pair database.

7. The computer-implemented method of claim 1, wherein generating a prompt further comprises employing a dynamic set of pairs of the target computer code and the original code determined based on a suitability context of the original code.

8. A system, comprising:
a memory device;
one or more processor devices operatively coupled with the memory device to:
construct augmented program metadata from an original code by generating target class structure and target method prototype;
filter extraneous code from the original code based on determined code compatibility to obtain filtered source code;
generate a prompt using pairs of the augmented program metadata and the filtered source code that are fed to a trained large language model to obtain generated translated code;
optimize the generated translated code to ensure code compilability, avoid redundancies, and enhance memory handling; and
translate a computer software application by compiling the generated translated code.

9. The system of claim 8, wherein one or more processor devices operatively coupled with the memory device to construct augmented program metadata further comprises generating refactored code from the original code to handle control flow statements that are compatible with the target computer code.

10. The system of claim 8, wherein one or more processor devices operatively coupled with the memory device to construct augmented program metadata further comprises determining parameters, return type and local variables from the original code for the target method prototype.

11. The system of claim 8, wherein one or more processor devices operatively coupled with the memory device to construct augmented program metadata further comprises analyzing a determined control flow graph of the original code to define relationships between code segments and accessed variables.

12. The system of claim 8, wherein one or more processor devices operatively coupled with the memory device to construct augmented program metadata further comprises analyzing reaching definitions using an affinity heuristic to associate target method prototype to target class structure.

13. The system of claim 8, wherein one or more processor devices operatively coupled with the memory device to generate a prompt further comprises employing a fixed set of pairs of the target computer code and the original code obtained from a code pair database.

14. The system of claim 8, wherein one or more processor devices operatively coupled with the memory device to generate a prompt further comprises employing a dynamic set of pairs of the target computer code and the original code determined based on a suitability context of the original code.

15. A computer program product for translating computer code using augmented program analysis, the computer program product comprising a computer readable storage medium having program instructions embodied therewith, the program instructions executable by a processor device to cause the processor device to:
construct augmented program metadata from an original code by generating target class structure and target method prototype;
filter extraneous code from the original code based on determined code compatibility to obtain filtered source code;
generate a prompt using pairs of the augmented program metadata and the filtered source code that are fed to a trained large language model to obtain generated translated code;
optimize the generated translated code to ensure code compilability, avoid redundancies, and enhance memory handling; and
translating a computer software application by compiling the generated translated code.

16. The computer program product of claim 15, wherein to construct augmented program metadata further comprises generating refactored code from the original code to handle control flow statements that are compatible with the target computer code.

17. The computer program product of claim 15, wherein to construct augmented program metadata further comprises determining parameters, return type and local variables from the original code for the target method prototype.

18. The computer program product of claim 15, wherein to construct augmented program metadata further comprises analyzing a determined control flow graph of the original code to define relationships between code segments and accessed variables.

19. The computer program product of claim 15, wherein to construct augmented program metadata further comprises analyzing reaching definitions using an affinity heuristic to associate target method prototype to target class structure.

20. The computer program product of claim 15, wherein to generate a prompt further comprises employing a dynamic set of pairs of the target computer code and the original code determined based on a suitability context of the original code.
